(19) United States
(12) Patent Application Publication
(10) Pub. No.: US 2011/0079748 A1
(43) Pub. Date: Apr. 7, 2011

(54) Exfoliation of Graphite Oxide in Propylene Carbonate and Thermal Reduction of Resulting Graphene Oxide Platelets

(76) Inventors: Rodney S. Ruoff, Austin, TX (US); Meryl D. Stoller, Austin, TX (US); Yanwu Zhu, Austin, TX (US)

(21) Appl. No.: 12/896,529

(22) Filed: Oct. 1, 2010

Related U.S. Application Data
(60) Provisional application No. 61/248,108, filed on Oct. 2, 2009.

(51) Int. Cl. H01G 9/022; C01B 31/00; C09K 3/00

(52) U.S. Cl. 252/62.2; 423/415.1; 252/182.12

(57) ABSTRACT

Disclosed are compositions and methods wherein graphite oxide was exfoliated and dispersed in propylene carbonate (PC) by bath sonication. Heating the graphene oxide suspensions at 150° C. significantly reduced the graphene oxide platelets; paper samples comprised of such reduced graphene oxide platelets had an electrical conductivity of 5230 S/m. By adding TEA BF₄ to the reduced graphene oxide/PC slurry and making a 2-cell ultracapacitor, specific capacitance values of about 120 F/g were obtained.

### CROSS REFERENCE TO RELATED APPLICATIONS

This application claims priority to U.S. Provisional Application Ser. No. 61/248,108, filed on Oct. 2, 2009, which is hereby incorporated by reference.

### BACKGROUND

1. Technical Field

The present disclosure relates to mixtures comprising graphite oxide and graphene oxide and products and uses thereof.

2. Technical Background

Graphite materials and graphene materials are useful for a number of applications, due to their important properties, including mechanical strength, electrical conductivity, among others. Small sheets of graphite and graphene materials are of particular interest, which can be as thin as a single atom. These materials have a variety of excellent properties that make them desirable for use in semiconducting applications among a variety of other applications.

Unfortunately, sheets of graphite and graphene materials are hard to produce, in part due to the fact that the sheets are typically hydrophobic and often agglomerate in processing media, such as a solvent. Many solvents that do not have the right range of cohesive energies that allow for the adequate dispersion of graphite or graphene sheets. Moreover, the starting materials, such as graphite oxide or graphene oxide, typically used to make sheets of graphene or graphite material are also particularly troublesome and often difficult to process. Consequently, production of stable suspensions of graphite materials, graphene materials, and sheets thereof, is a significant challenge.

The exfoliation of graphite oxide (GO) followed by reduction of the resulting graphene oxide platelets is the only route reported to date that affords the large scale processing of graphene-based materials in colloidal suspensions. In particular, the importance of solution-processable graphene oxide (by the exfoliation of GO) has been demonstrated by the fabrication of paper-like films, transparent conductive electrodes, and conductive polymeric and ceramic composites. Since a stable colloidal suspension of graphene oxide platelets can be obtained by the simple sonication of GO in water, much of the solution processing of graphene oxide reported to date has been carried out in aqueous media. Aqueous dispersions of reduced graphene oxide (RG-O) nanoplatelets have been obtained by changing the pH to about 10 prior to reduction with hydrazine. The dispersion of RG-O in water at a pH of approximately 7 can be achieved by addition of poly(sodium 4-styrenesulfonate) to the aqueous suspension of graphene oxide platelets prior to addition of hydrazine. The preparation of large-scale graphene oxide dispersions in other solvents, particularly organic solvents, is also highly desirable and may further broaden the scope of applications and facilitate the practical use of graphene-based materials. The dispersion behavior of GO in different organic solvents has also been investigated, wherein the full exfoliation of GO and stable dispersion of graphene oxide can be obtained in N,N-dimethylformamide (DMF), N-methyl-2-pyrrolidone (NMP), tetrahydrofuran (THF) and ethylene glycol (EG). It has recently been reported that colloidal suspensions of highly reduced graphene oxide in a wide range of organic solvents have been achieved by diluting the colloidal suspension of RG-O platelets in DMF/H₂O (9:1) with organic solvents such as DMF, NMP, ethanol, acetonitrile (AN) and dimethylsulfoxide (DMSO), among others. The dispersion of graphene oxide in chloroform has been realized by transferring surfactant decorated graphene oxide from water to chloroform.

Graphene oxide is electrically insulating and various reduction methods have been developed to restore the conjugated network and electrical conductivity of graphene. Reducing agents such as hydrazine and dimethylhydrazine have been used to reduce graphene oxide. Other chemicals like hydroquinone and NaBH₄ have also been used. A flash-assisted reduction of films composed of graphene oxide platelets and their polymer composites has been demonstrated, where a flash beam with an energy flux of about 1 J/cm² was used to irradiate and heat the samples to over 100° C. to trigger thermal reduction. A method involving heating graphene oxide suspension in water under alkaline conditions has been proposed as a ‘green’ route to suspensions of RG-O. Direct thermal treatment at elevated temperatures provides another method to reduce individual graphene oxide platelets adhered to a substrate, without using reducing agents. ‘Thermal shock’ of GO powders at temperatures up to ˜1050° C. has also been used, and there is a long history of thermal shocking of intercalated graphite powders as presented in numerous articles in the peer-reviewed literature. Recently, a ‘hydrothermal dehydration’ for the reduction of graphene oxide platelets in supercritical water at 180° C. has been discussed. This ‘water-only’ route partially removed the oxygen functional groups from the graphene oxide and repaired the aromatic structures.

Even with these developments, the processing and handling of graphite and graphene materials for certain applications remains challenging. Thus, there is a need to address the problems and other shortcomings associated with the production and processing of graphite and graphene materials. These needs and other needs are satisfied by the compositions and methods of the present disclosure.

### SUMMARY

In accordance with the purpose(s) of the invention, as embodied and broadly described herein, this disclosure, in one aspect, relates to mixtures comprising graphite material and graphene material and products and uses thereof.

In one aspect, the present invention provides a composition comprising a suspension of at least one of a graphite material or a graphene material in a non-aqueous liquid.

In another aspect, the present invention provides a composition comprising a suspension of at least one of a graphite material or a graphene material in a solution comprising propylene carbonate.

In still another aspect, the present invention provides a method for preparing a reduced graphene oxide material, the method comprising exfoliating graphite oxide in a non-aqueous solvent to provide a suspension.

In still another aspect, the present invention provides a method for preparing a reduced graphene oxide material, the method comprising exfoliating graphite oxide in propylene carbonate, and then reducing at least a portion of the graphene platelets.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1 depicts (a) optical photos of a graphene oxide suspension in propylene carbonate (PC) (left) before and (right) after heating at 150° C. for 12 hours, (b) a typical SEM image of graphene oxide platelets deposited on a Si substrate, (c) a typical AFM image of graphene oxide platelets dispersed on mica, and (d) a corresponding line profile.

FIG. 2 depicts (a) a typical SEM image of the RG-O powder obtained by heating graphene oxide in PC at 150° C., (b) a high magnification SEM image indicating curved and transparent platelets, (c) a TEM image of the RG-O platelets from the 150° C. treatment and the corresponding SAED pattern, and (d) a HRTEM image of the sample in (c).

FIG. 3 depicts (a) a SEM image of the RG-O paper from the 150° C. treatment (insets show (top) an optical image of the paper and (bottom) cross section SEM image of the paper), (b) XRD, (c) XPS, and (d) TGA characterizations of the RG-O synthesized at 150 and 200° C., with those of GO powder as a reference in each case.

FIG. 4 depicts (a and b) RG-O derived from 150° C. treatment. (a) CV curves. Different scan rates are labeled with the average specific capacitance values marked. (b) Galvanostatic charge/discharge curves at a constant current of 5 mA. (c and d) RG-O derived from the 200° C. treatment. (c) CV curves. Different scan rates are labeled with the average specific capacitance values marked. (d) Galvanostatic charge/discharge curves at a constant current of 5 mA.

FIG. 5 depicts optical images of GO with variable pH values (pH 10, left; pH 7, center; pH 3, right) in PC, after 2 hours of bath sonication.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a graphene sheet,” “an electrode,” or “an electrolyte” includes mixtures of two or more graphene sheets, electrodes, or electrolytes, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps.

As used herein, the term “suspension” refers to a mixture comprising a liquid and a material suspended therein. Generally, the material suspended in the liquid is not dissolved nor substantially aggregated, but rather dispersed in the liquid. A material can be suspended in a liquid; however, it is not necessary that any portion of the suspended material be partially or wholly dissolved in the liquid. In one aspect, a suspension can comprise only one or more suspended materials disposed in one liquid or a mixture of liquids. In another aspect, a suspension can comprise a solution, wherein all or a portion of a suspended material is dissolved in the liquid or mixture of liquids. In yet another aspect, a suspension can comprise one or more suspended materials disposed in one or more liquids, wherein a portion of the suspended material is also dissolved in the one or more liquids. When a suspension is disclosed herein as being “substantially homogenous,” this is meant to refer to a mixture comprising a liquid having a material dispersed substantially throughout the liquid. To determine whether or not a suspension is “substantially homogenous,” a suspension can be, for example, visually inspected. If a suspension comprises deposits or obvious aggregates, the suspension is not “substantially homogenous.” Other methods include, for example, X-ray diffraction, sedimentation analysis, among others.

As used herein, the term “graphite material” refers to any material that comprises graphite. The term “graphite” refers to any form of graphite, including without limitation natural and synthetic forms of graphite, including, for example, crystalline graphites, expanded graphites, exfoliated graphites, and graphite flakes, sheets, powders, fibers, pure graphite, and graphite. When graphite is present, one or more graphitic carbons can have the characteristics of a carbon in an ordered three-dimensional graphite crystalline structure comprising layers of hexagonally arranged carbon atoms stacked parallel to each other. The presence of a graphitic carbon can be determined by X-ray diffraction. As defined by the International Committee for Characterization and Terminology of Carbon (ICCTC, 1982), and published in the Journal Carbon, Vol. 20, p. 445, a graphitic carbon can be any carbon present in an allotropic form of graphite, whether or not the graphite has structural defects.

As used herein, the term “graphene material” refers to any material that comprises graphene. The term “graphene” refers to any form of graphene, including without limitation natural and synthetic forms of graphene, including, for example, intercalated and non-intercalated graphene, chemically-functionalized graphene, stabilized graphene, and graphene. Any of the aforementioned graphene materials can be present in the form of a ribbon, sheet, a multilayer of sheets, a single atomically thick sheet, among other forms. The presence of graphene can be determined by microscopic methods, including without limitation AFM, TEM, SEM, and the like, and for example, by spectroscopic methods such as Raman.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly discussed above, the present disclosure relates generally to mixtures comprising graphite material or graphene material and products and uses thereof. Specifically disclosed are dispersions of GO in propylene carbonate (PC) prepared, in one aspect, via sonication for the formation of stable suspensions of graphene oxide platelets. In another aspect, other methods of preparing a suspension can be employed, such as, for example, shaking, agitating, and/or subjecting to stirring. In another aspect, the graphite and/or graphene material can form a suspension without the need for additional mechanical forces.

In one aspect, the suspension comprises a graphite material, a graphene material, or a combination thereof. As discussed above, the graphite material or graphene material can be any material that comprises any form of a graphite or graphene. In one aspect, the suspension can be used as a starting material suspension for the processing of the graphite material or graphene material. Examples of graphite and graphene starting materials include without limitation graphite oxide and graphene oxide. Thus, in one aspect, the graphite material or graphene material can be graphite oxide, graphene oxide, or a combination thereof.

In one aspect, the suspension of a graphite and/or a graphene material can be in a non-aqueous liquid. In another aspect, the non-aqueous liquid can comprise propylene carbonate. In yet another aspect, the non-aqueous liquid can consist essentially of propylene carbonate. In yet another aspect, the non-aqeuous liquid can consist of propylene carbonate. In still another aspect, the suspension can be free or substantially free of water. In one aspect, the suspension can be homogeneous or substantially homogeneous. In still another aspect, at least a portion of the graphite and/or graphene material in a suspension is non-intercalated.

In one aspect, colloidal suspensions of conducting graphene sheets decorated/coated by surfactants/stabilizers (e.g. polymers, nanoparticles, small molecules, and polar solvents) can be produced. Thus, the suspensions can optionally comprise a stabilizer. Stabilizers can be used to aid in the dispersion or reduce aggregation of a graphite or graphene material in a liquid medium. An example of a stabilizer is poly(m-phenylenevinylene-co-2,5-dioctoxy-p-phenylenevinylene) (PmPV). In another aspect, stabilizers can include surfactants. In another aspect, a surfactant is not necessary. Thus, in one aspect, a surfactant and/or a stabilizer is not present. In one aspect, exemplary surfactants include without limitation 1,2-distearoyl-sn-glycero-3-phosphoethanolamine-N [methoxy(polyethyleneglycol)-5000] (DSPE-mPEG). In one aspect, 1,2-distearoyl-sn-glycero-3-phosphoethanolamine-N [methoxy(polyethyleneglycol)-5000] (DSPE-mPEG) is not present.

In a further aspect, the suspension comprises a graphite or graphene material that has been modified from a starting graphite or graphene material. Modified graphite and graphene materials include without limitation at least one of chemically-functionalized graphene, reduced graphene, or graphene. An example of reduced graphene is highly reduced graphene. In one aspect, the graphene material can be highly reduced graphene. “Highly reduced graphene” refers to graphene oxide that has been substantially reduced, or, for example, reduced to a level that imparts a desired conductivity to the reduced graphene. Thus, in one aspect, the graphene material can be electrically conductive. It is known in the art that oxygen containing functional groups, when present on graphene, can interfere with electrical conductivity. It should be noted that it is not necessary that a reduced or highly reduced graphene material comprise only hydrogen and carbon elements. In one aspect, a reduced or highly reduced graphene is fully hydrogenated. In another aspect, one or more sites of a reduced or highly reduced graphene material can comprise another element, such as for example, a nitrogen or oxygen.

In a still further aspect, the graphene material can be chemically-functionalized graphene, including chemically-modified graphene (CMG), which includes one-atom thick sheets of carbon optionally functionalized with other elements. If a particular surface of a chemically modified graphene material, or a portion thereof, is functionalized, such functionalization can comprise multiple functional groups and can be uniform or can vary across any portion of the surface. In addition, functionalization can be to any extent suitable for use in a particular device. In one aspect, the degree of functionalization can be about up to the level wherein the conductivity of the CMG material is no longer suitable for use in a desired application or device.

In one aspect, the use of propylene carbonate can, in one aspect, achieve exfoliated GO dispersions. Furthermore, thermally treating such a suspension at about 150° C. can, in another aspect, remove a significant fraction of the oxygen functional groups and yield an electrical conductivity for a film composed of such ‘reduced graphene oxide’ (RG-O) platelets to a value as high as, for example, about 5,230 S/m. Since PC is frequently used as a high-permittivity component of electrolytes, the RG-O platelets obtained by heating graphene oxide suspensions in PC can, in various aspects, provide an economical processing route for such applications as electrode materials for ultracapacitors. For example, an ultracapacitor cell based on RG-O electrodes and an organic electrolyte (PC with tetraethylammonium-tetrafluoroborate, TEA-BF₄) commonly used in commercial ultracapacitors can be prepared that, in one aspect, yields specific capacitance values greater than 120 F/g. In other aspects, such an ultracapacitor can have a higher specific capacitance depending on the specific RG-O materials used and the specific method of preparation. In various aspects, an inventive RG-O based ultracapacitor cell can have a specific capacitance of at least about 110 F/g, at least about 115 F/g, at least about 120 F/g, at least about 122 F/g, at least about 124 F/g, at least about 126 F/g, at least about 128 F/g, at least about 130 F/g, at least about 135 F/g, at least about 140 F/g, or higher.

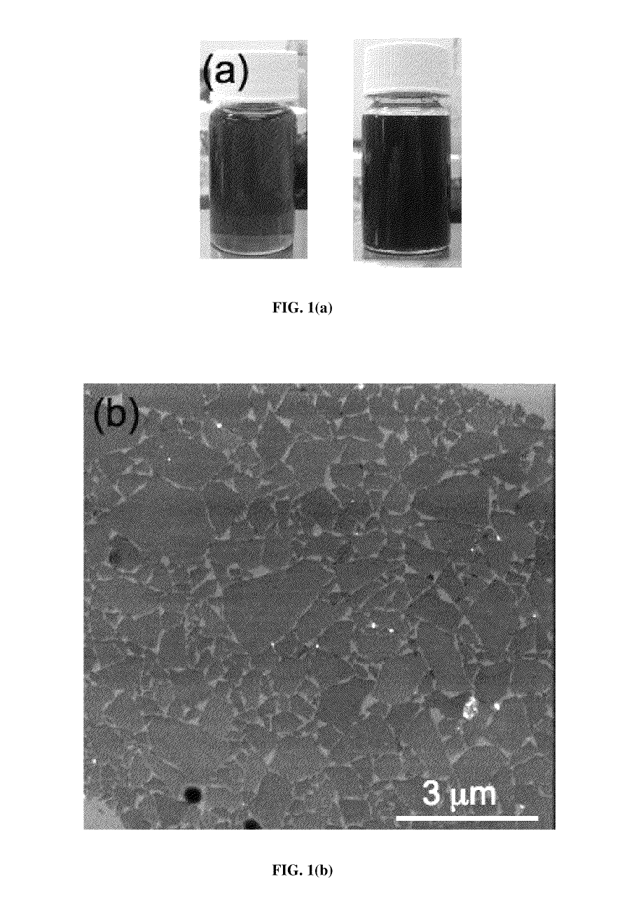

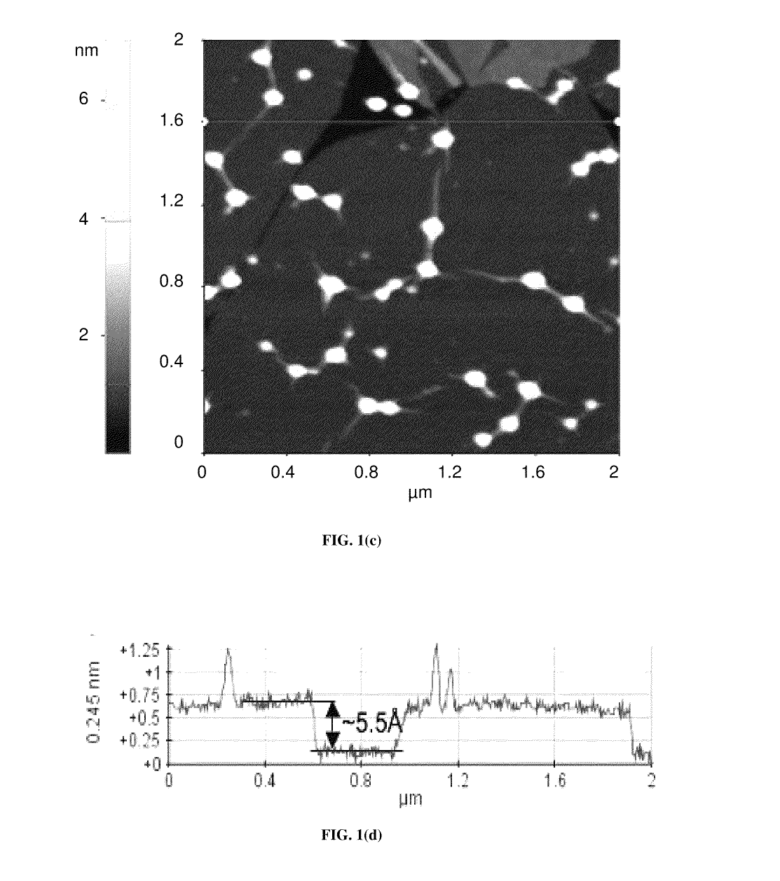

With reference to the figures, FIG. 1(a) (left image) shows that one hour of bath sonication generated a uniform brown-colored graphene oxide suspension in PC; the suspension remaining stable for several months without any precipitation evident to the eye. The average value of the zeta potential from a series of measurements (on the same sample) was −45±1 mV for a suspension with a 1 mg/ml concentration at pH 3. In one aspect, the high electrostatic repulsion of graphene oxide in PC is likely thus responsible for the suspension's stability. Thus, in one aspect, a suspension of graphene oxide capable of remaining stable for an extended period of time, such as, for example, 2, 3, 4 months or more is disclosed. This value is comparable to those reported for aqueous suspensions of graphene oxide platelets at pH 7 (˜36 mV) and aqueous suspensions of RG-O platelets with pH of around 10 (˜42 mV). In one aspect, a pH of about 3 can yield a large-scale dispersion and exfoliation of GO in PC. In another aspect, when the pH was increased to about 7 and about 10, a low concentration of GO dispersion in PC could be achieved by bath sonication. While not wishing to be bound by theory, the high dipole moment of PC, 5.0 D, can, in various aspects, play a role in dispersing graphene oxide sheets.

To evaluate the degree of exfoliation of the GO into graphene oxide platelets, an exemplary diluted suspension with 0.05 mg/ml concentration (diluted from 1 mg/ml) can be dropped onto Si substrates with a native oxide layer followed by drying and inspection with scanning electron microscopy (SEM). As seen from the SEM image in FIG. 1(b), a closely packed ‘tiling’ of graphene oxide platelets with a uniform contrast can be observed on the substrate. In one aspect, the platelets have lateral dimensions ranging from several hundred nanometers to several micrometers and fit together in edge-to-edge configurations. In another aspect, no significant folding or overlapping was observed, further indicating a strong repulsion between the graphene oxide platelets, similar to the Langmuir-Blodgett (LB) assembly of graphene oxide platelets. In yet another aspect, atomic force microscopy (AFM) can be used to measure the surface morphology and thickness of graphene oxide platelets exfoliated in PC. FIG. 1(c) shows a typical topography image of graphene oxide platelets on a mica substrate. From the figure, the uniformity of the contrast of platelets is apparent. In another aspect, wrinkles can be observed decorated with protruding spots. From the corresponding line profile in FIG. 1(d), a thickness of ˜5.5 Å can be obtained from the graphene oxide platelets. It should be noted that not only is this value about half that of the 1-1.2 nm thickness of typical graphene oxide platelets exfoliated in water, but also less than that of RG-O in water (−1 nm) or in a 9:1 DMF/H₂O mixture (0.7˜0.8 nm), when reduced by hydrazine. Thus, in one aspect, the various methods recited herein can provide graphene oxide platelets having a thickness less than or substantially less than those obtained from an aqueous exfoliation process. In another aspect, the methods of the present invention can be carried out in the absence of water or substantially absent of water. In various aspects, the inventive methods described herein can provide graphene oxide platelets having a thickness of less than about 1.0 nm, less than about 0.9 nm, less than about 0.8 nm, less than about 0.7 nm, or less than about 0.6 nm. In a specific aspect, the inventive methods can provide a graphene oxide platelet having a thickness of about 5.5 Å.

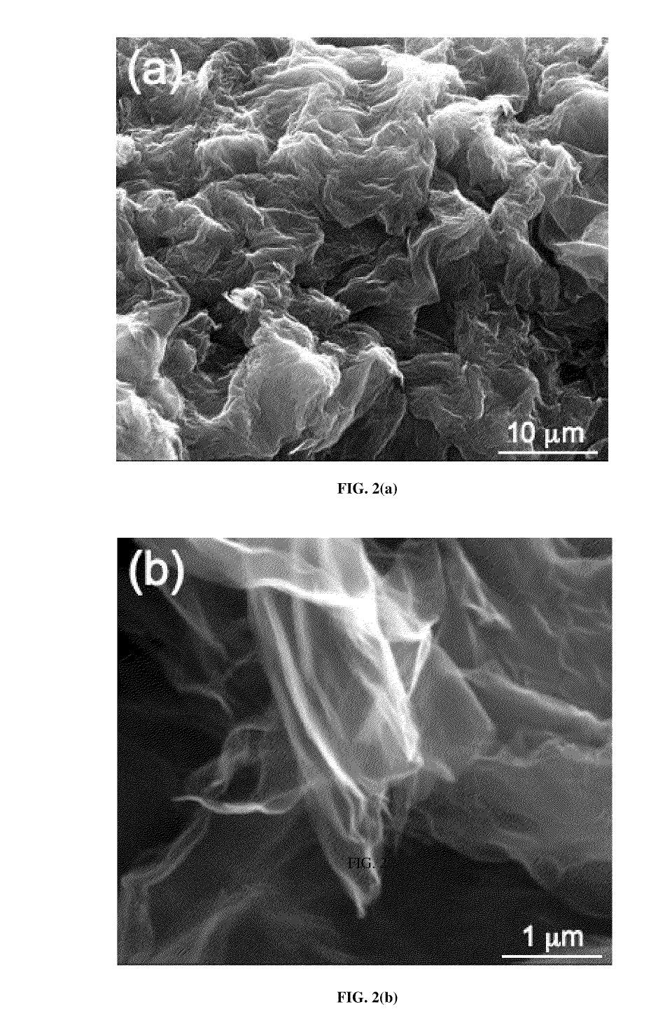

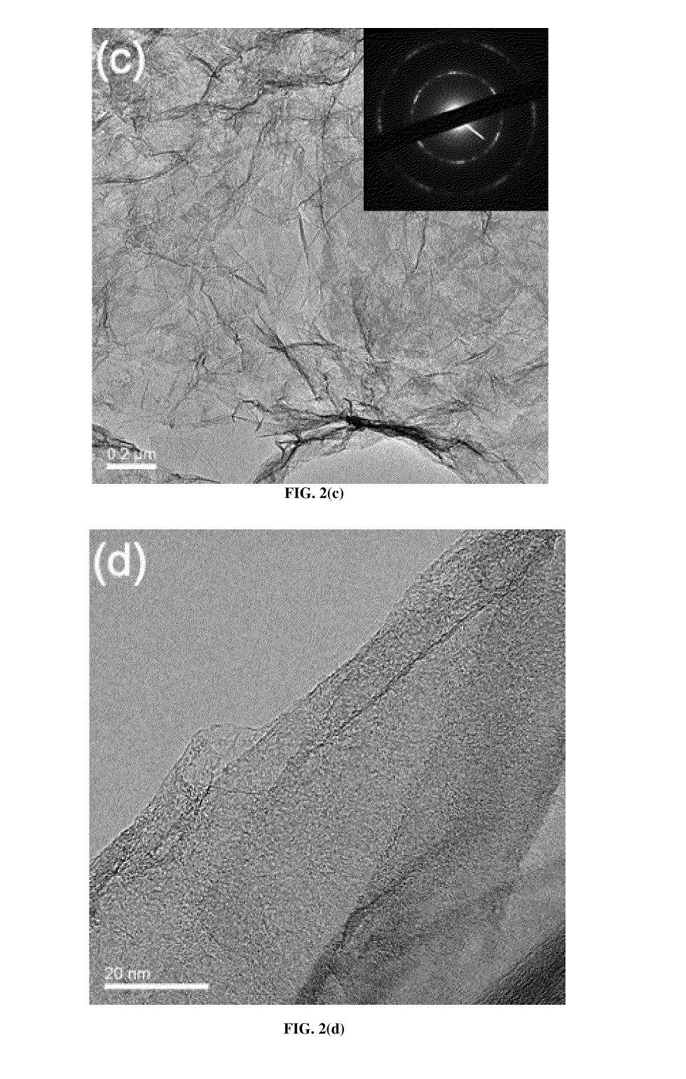

In one aspect, the relatively high boiling point (˜240° C.) of PC can allow the reduction of the as-dispersed graphene oxide by heating the suspension at moderate temperatures. In such an aspect, the suspension can become black after being heated in an oil bath at 150° C. for 12 hours, as shown by the optical photo in FIG. 1(a) (right image). The color change indicates different optical properties of the heated graphene oxide platelets, likely caused by the removal of oxygen-containing functional groups. Unlike the RG-O in water reduced by hydrazine at pH 7 which irreversibly agglomerates, the RG-O suspension in PC obtained by thermal treatment can, in one aspect, be a homogeneous black suspension, with only very small particles in the suspension visible to the eye. In such an aspect, the RG-O suspension thus obtained could last for several hours, such as, for example, at least about 2 hours or at least about 5 hours, before significant precipitation was observed. In another aspect, by filtration of the as-heated (reduced) graphene oxide suspension followed by vacuum drying, RG-O powders can be obtained and analyzed using the SEM. From FIG. 2(a), such an RG-O powder can have platelets displaying a fluffy and crumpled morphology, similar with that of RG-O obtained by reducing the graphene oxide suspension in water with hydrazine. The high magnification SEM image shown in FIG. 2(b) illustrates, in one aspect, thin and wrinkled sheets transparent to electrons. RG-O samples can be prepared for transmission electron microcopy (TEM) by dropping an RG-O suspension on Cu grids followed by vacuum drying. FIG. 2(c) illustrates a typical TEM image from the RG-O sample that was thermally reduced at 150° C. in PC. In such an aspect, the RG-O platelets have wrinkles and folded regions. From these overlapped and folded platelets, the select area electron diffraction (SAED) in the inset of FIG. 2(c) yields a ring-like pattern consisting of many bright spots. Those spots make regular hexagons with different rotational angles between such hexagons, indicating the essentially random overlay of individual RG-O platelets. A high resolution TEM (HRTEM) image from the same sample is shown in FIG. 2(d). From the fringes of the folded regions, this region of the sample is composed of a stack of RG-O platelets with the number of layers ranging from 2 to >10.

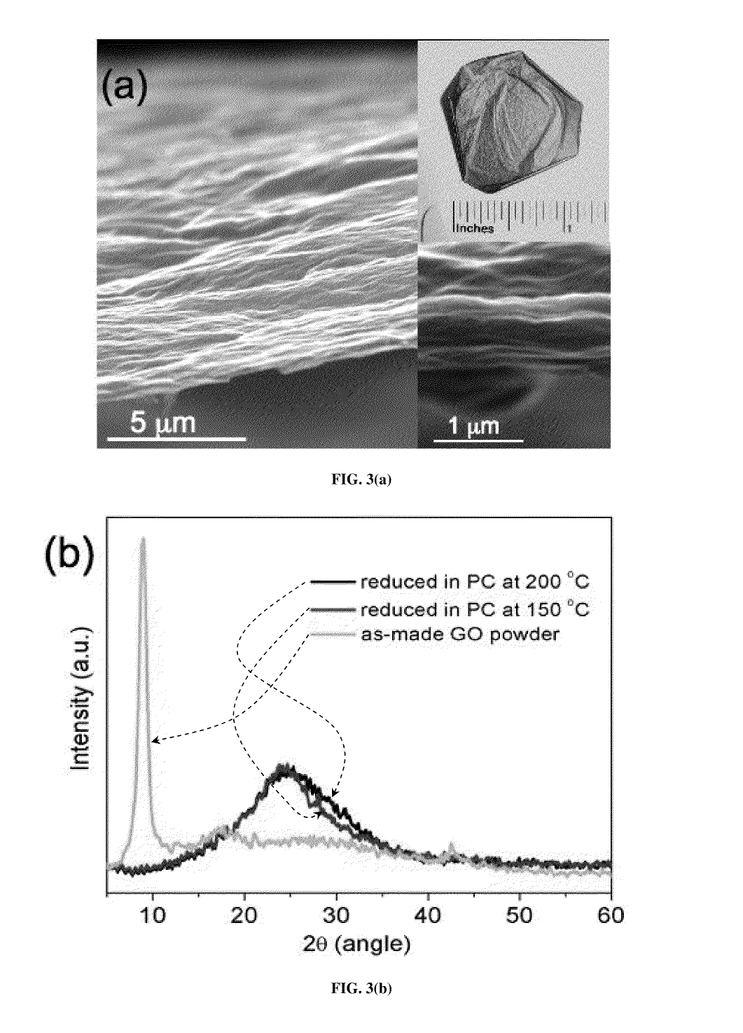

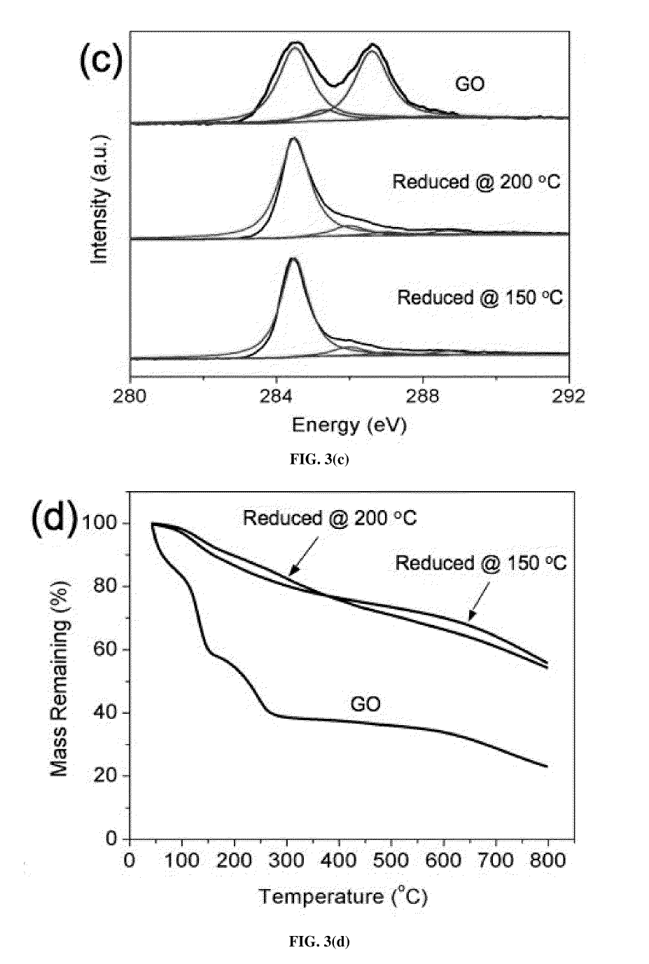

In one aspect, freestanding paper-like RG-O materials with a thickness of about 700 nm can be obtained when a small amount (e.g., 2 ml for the concentration of 1 mg/ml) of RG-O suspension in PC was deposited by vacuum filtration on a 0.2-μm alumina membrane. The film can be peeled off the membrane filter, and subsequently dried in vacuum at 80° C. to decreas the amount of PC in the paper. As shown in the optical image in the upper inset of FIG. 3(a), a shiny RG-O paper at an inch scale was obtained with folded edges, from the RG-O suspension. The bottom inset of FIG. 3(a) shows a cross-section SEM image of the RG-O paper. The layered structure of the RG-O paper indicates that the RG-O platelets are well dispersed in the PC.

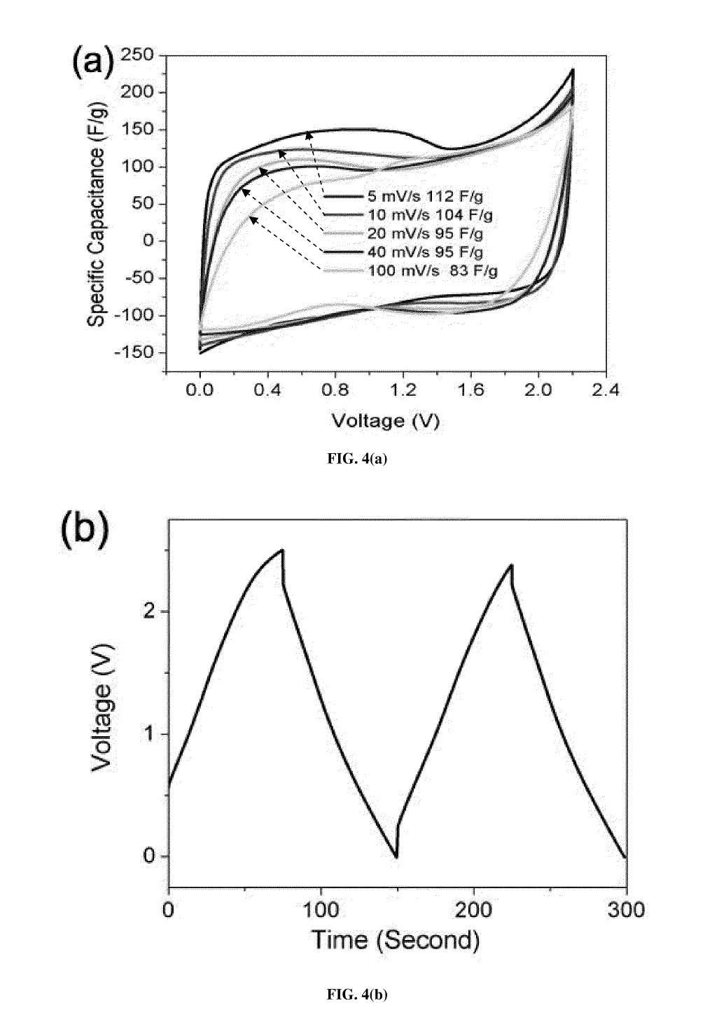

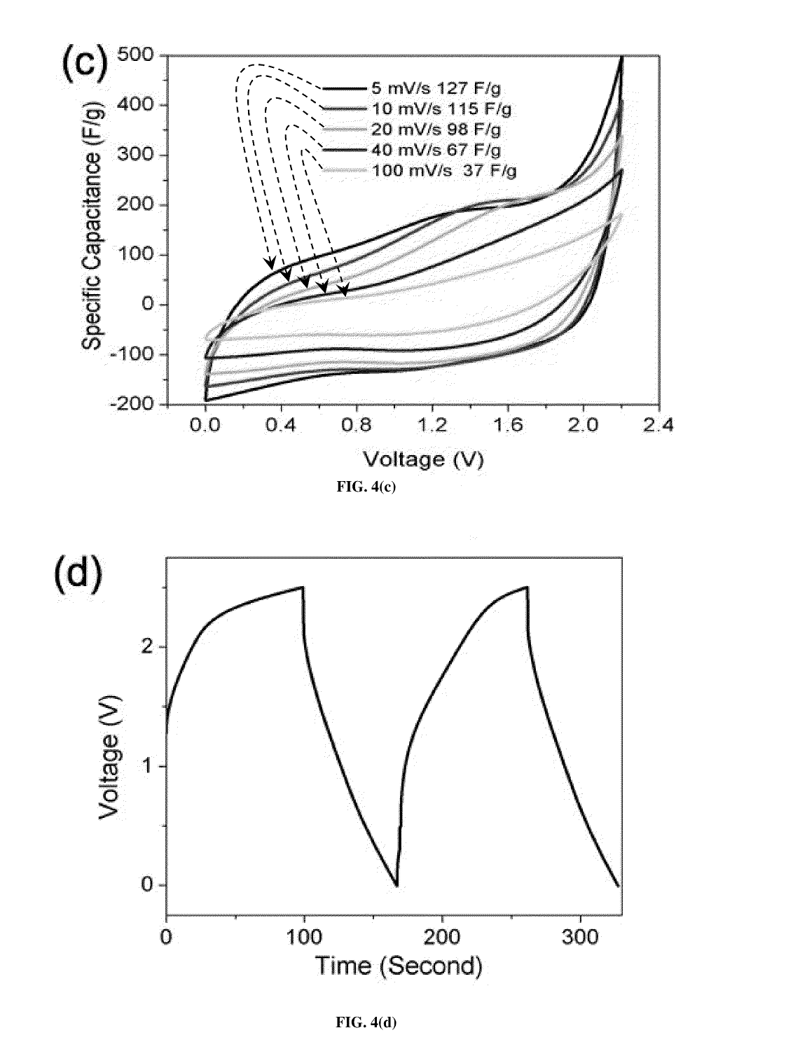

In one aspect, the suspension of graphene oxide platelets in PC can also be heat-treated at a higher temperature, such as, for example, 200° C. for 12 hours. In one aspect, sample RG-O powders and papers obtained from heating at 200° C. had a similar morphology with the RG-O obtained from heating at 150° C. FIG. 3(b) shows the X-ray diffraction (XRD) patterns for GO powder, and from the papers generated by the 150° C. and 200° C. treatments. A dominant peak was observed at 2θ=9.1° from GO powder, corresponding to an interlayer distance of 0.97 nm (at a relative humidity of around 35%). After heating the suspension of graphene oxide in PC, this peak completely disappeared and broad peaks centered at around 25° C. were observed, corresponding to an interlayer spacing of about 0.36 nm, comparable to that (0.37 nm) of RG-O papers made from RG-O platelets obtained by hydrazine treatment of graphene oxide dispersed in a 9:1 DMF/H₂O mixture. The influence of the heat treatments of the graphene oxide suspended in PC has been evaluated by X-ray photoelectron spectroscopy (XPS) of paper-like samples. FIG. 3(c) shows that the deconvoluted peaks with binding energies higher than 284.5 eV (sp² carbon) were largely suppressed for the paper samples consisting of RG-O platelets. The peaks between 286-289 eV are typically assigned to epoxide, hydroxyl, and carboxyl groups. The XPS results suggest that these oxygen-containing groups have been effectively removed by the thermal treatment. Furthermore, the C/O atomic ratio calculated from the XPS spectra is 1.7 for the GO powders but 8.3 and 6.8 for RG-O papers obtained by heating graphene oxide suspensions in PC at 150 and 200° C., respectively. (It should be noted that the C/O ratio values for RG-O papers may include a contribution from the residual PC.) The ratio obtained here from heating at 150° C. (8.3) is slightly higher than those of papers of ‘RG-O’ obtained by treatment of aqueous suspensions of graphene oxide with NaBH₄ (5.3) and hydrazine (6.2), is comparable to the results from hydrazine vapor (8.8) or thermal treatment at 500° C. (6.8-8.9) of graphene oxide films, but is lower than the values obtained by thermal treatment of the graphene oxide films at temperatures between 700 and 1000° C. (11.36-14.1). The results from thermal gravimetric analysis (TGA) under nitrogen flow with a heating rate of 1° C./min are shown in FIG. 4(d). Three significant weight loss events were observed for GO powders, corresponding to the evaporation of water (below 100° C.) and the loss of what should be carbon oxide gas species (120-150° C. and 200-260° C.) from the decomposition of labile oxygen functional groups. In contrast, the RG-O powders obtained by heating graphene oxide suspensions in PC and then drying, have less than about 2% of weight loss below 100° C. While not wishing to be bound by theory, the gradual weight loss (about 20%) below 350° C. is likely due to the evaporation of trapped PC and/or the loss of residual functional groups on the RG-O platelets in these RG-O powders.

To further test whether the dispersed graphene oxide platelets were rendered conductive by heating their suspension in PC at moderate temperatures, the electrical sheet resistance of the RG-O papers was measured using the van der Pauw four probe method. The value for the average thickness of each of these papers was obtained from the respective cross-section SEM images. For each heating temperature (150 or 200° C.), two samples were measured, and on three different positions for each sample. The average conductivity of RG-O papers dried in vacuum at 80° C. was about 2,100 and 1,800 S/m for the samples from the 150 and 200° C. treatments, respectively. In an attempt to remove residual PC in the RG-O papers, the samples were further dried at 250° C. for 12 hours in a tube furnace under vacuum (˜60 mTorr). The drying improved the conductivity to about 5,230 and 2,640 S/m for the samples derived from the 150 and 200° C. treatments, respectively. Thus, in one aspect, a reduced graphene oxide material is free of or substantially free of the non-aqueous liquid, such as, for example, propylene carbonate. In various aspects, an RG-O paper formed by the methods described herein can have an electrical conductivity of at least about 2,000 S/m, at least about 2,200 S/m, at least about 2,400 S/m, at least about 2,600 S/m, at least about 2,800 S/m, at least about 3,000 S/m, at least about 3,500 S/m, at least about 4,000 S/m, at least about 4,500 S/m, at least about 5,000 S/m, at least about 5,200 S/m, or more.

Table 1 shows that the electrical conductivities of the RG-O papers derived from heating of graphene oxide suspensions in PC are comparable to the best results of RG-O obtained by chemical reduction of graphene oxide suspensions or from thermal shock of GO powders at 1050° C., with the exception of samples reduced in a 9:1 DMF/H₂O mixture with hydrazine and for samples reduced with NaBH₄ followed by heating in H₂SO₄ and then further heating at 1100° C. in a H₂/Ar (15%/85%) mixture.

TABLE 1

| Materials/reduction Method | Electrical properties |
|---|---|
| Heating GO (50-90° C.) in alkaline conditions | Unknown |
| Hydrothermal treatment of GO in supercritical | Conductive (powder resistance of ~40 Ω) |
| water (120-180° C.) | |
| Reduction of GO by sodium borohydride | Highest conductivity of 45 S/m |
| Flash reduction of GO | Conductivity of ~1000 S/m |
| Hydrazine reduction of GO | Powder conductivity of 200 S/m |
| Hydrazine reduction of KOH-modified | Conductivity of 690 S/m |
| graphene oxide | |
| Hydrazine reduction of GO in DMF/water | Air drying 1700 S/m |
| mixture (HRG) | Annealing at 150° C. 16000 S/m |
| Hydrazine reduction of GO in ammonia | Conductivity of ~7200 S/m |
| solution | |
| Pre-reduction of GO by NaBH₄ - | Conductivity of 1250 S/m |
| sulphonation - Post reduction with hydrazine | |
| Pre-reduction of GO by NaBH₄ - Heating in | Conductivity of 20200 S/m |
| H₂SO₄ -Post annealing at 1100° C. in Ar/H₂ | |
| Rapid heating of GO up to 1050° C. | Powder conductivity of 1000-2300 S/m |
| Reduced graphene oxide in PC at 200° C. | ~1800 S/m |
| | Annealing at 250° C. ~2640 S/m |
| Reduced graphene oxide in PC at 150° C. | ~2100 S/m |
| | Annealing at 250° C. ~5230 S/m |

In one aspect, the inventive method for achieving dispersed RG-O platelets provides a straightforward method to reduce graphene oxide platelets dispersed in PC. TGA data, as illustrated in FIG. 3(d), indicates a third significant weight loss for GO powders occurring in a range of 200-260° C. In contrast to conventional thermal heating of GO samples, increasing the temperature of graphene oxide suspension in PC to, for example, about 200° C. can result in a lower C/O ratio, slightly higher weight loss at elevated temperatures (>350° C.) in TGA, and/or lower conductivity for paper-like samples composed of the RG-O platelets, than for the thermal treatment at, for example, 150° C.

In another aspect, the inventive RG-O material can also be used as an ultracapacitor electrode material. Commercial ultracapacitors typically utilize tetraethylammonium tetrafluoroborate (TEA BF₄) in PC or acetonitrile (AN) for electrolytes. In one aspect, a RG-O material is suitable for use with an ionic liquid electrolyte. In one aspect, since PC was used as the solvent during the exfoliation and thermal reduction, TEA BF₄ was added to the PC (1 M) to form an electrolyte. A “doctor blade” method was used to apply RG-O/PC/TEA BF₄ slurry onto current collectors for assembly of a two-electrode ultracapacitor cell. In such an aspect, the performance of the RG-O based cell was analyzed using cyclic voltammetry (CV) and galvanostatic charge/discharge. FIG. 4(a) shows the CV curves of the ultracapacitor made from RG-O in PC that was treated at 150° C. With the exception of the higher scan rates, the CV curves have a rectangular shape, indicating good capacitive behavior. A specific capacitance of 112 F/g calculated from CV data was obtained for a scan rate of 5 mV/s. FIG. 4(b) shows a galvanostatic charge/discharge curve at a constant current of 5 mA (corresponding to a charge/discharge rate of 830 mA/g). From the curve, a specific capacitance of about 112 F/g was calculated, consistent with the values obtained from the CV tests for the scan rate of 5 mV/s. FIGS. 4(c) and 4(d) show CV and galvanostatic charge/discharge curves for the sample treated at 200° C. As can be seen, the CV curves in FIG. 4(c) demonstrate different features from those of the 150° C. sample. First, the shape of the CV curves from the 200° C. sample are not as rectangular with a nonlinear increase in current with increased voltage. Next, a higher specific capacitance of 127 F/g was calculated for the 5 mV/s scan rate, but the specific capacitance rapidly decreases with an increase in the scan rate. Finally, the charging and discharging curves are asymmetric, suggesting irreversible faradic processes are occurring during charging. The charge/discharge curve in FIG. 4(d) from the ‘200° C. sample’ at 5 mA (corresponding to a charge/discharge rate of ˜1000 mA/g) gave a specific capacitance of about 122 F/g. Compared with the results from the 150° C. sample in FIG. 4(b), the nonlinear charging shown in FIG. 4(d) could suggest a slow ion diffusion/transport, likely due to the higher resistance and remaining (and/or newly induced during the thermal treatment) oxygen functional groups of the 200° C. sample. Compared with previous studies on ultracapacitors based on RG-O reduced with hydrazine, the inventive RG-O prepared by heating graphene oxide suspensions in PC yields an improvement of ˜20% in terms of specific capacitance and compares favorably with the performance of other electrode materials (80-120 F/g) using PC based electrolytes.

In one aspect, an ultracapacitor is disclosed that comprises a reduced graphene oxide. In another aspect, an ultracapacitor comprises a reduced graphene oxide, such as, for example, can be prepared by the inventive methods described herein, and is capable of operating at a voltage of at least about 2.7 V. In yet another aspect, an ultracapacitor comprises a reduced graphene oxide that has not been exposed to water or to an appreciable quantity of water so as to adversely affect performance of the resulting capacitor. In one aspect, an ultracapacitor comprising a reduced graphene oxide can further comprise an organic solvent, such as, for example, propylene carbonate, acetonitrile, or a combination thereof. In another aspect, an ultracapacitor comprising a reduced graphene oxide can further comprise an ionic liquid electrolyte.

Thus, in one aspect, the exfoliation and thermal reduction of suspensions of graphene oxide platelets in propylene carbonate is disclosed. In another aspect, thermally treating suspensions at 150° C. can significantly reduce the graphene oxide platelets. In another aspect, the high degree of dispersion and subsequent effective reduction of graphene oxide platelets in propylene carbonate can be useful, for example, in the production of reduced graphene oxide on a large scale. This scalable and potentially green process can enable important commercial applications for graphene materials. For example, in one aspect, the use of this material in propylene carbonate, for electrical energy storage by adding TEA BF₄ to the RG-O/PC slurry and applying it to an ultracapacitor cell has been demonstrated, providing performance rivaling activated carbon materials currently used in commercial ultracapacitors.

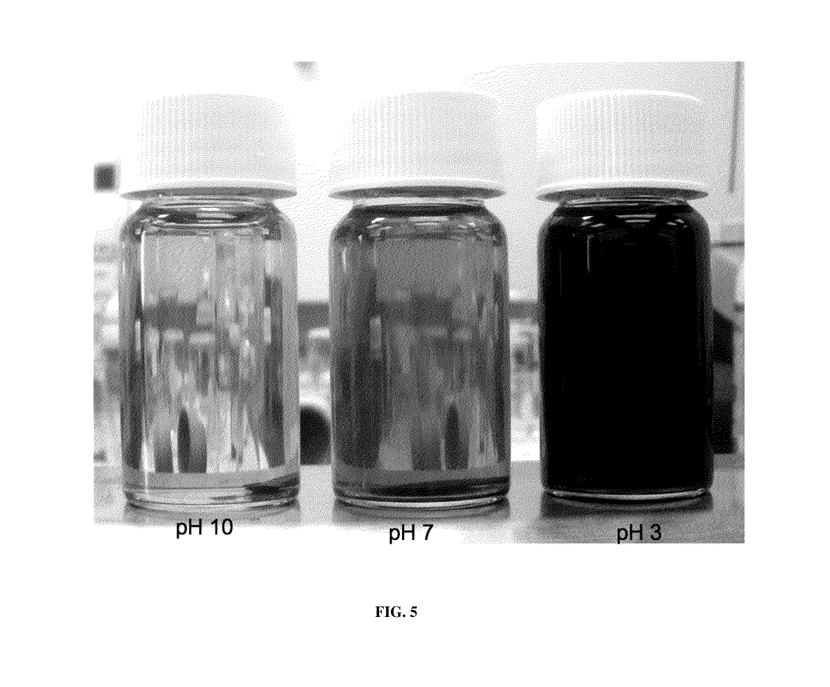

In another aspect, the pH of a graphite oxide (GO) can have a significant effect on the degree of dispersion in propylene carbonate (PC). In one aspect, during the preparation of GO powder, 10% HCl solution in water (200 ml) was used to wash the GO slurry before drying in vacuum. In such an aspect, the as-made GO dispersed in water or PC has a pH of about 3 (for 1 mg/ml). In a further aspect, to tune the pH of GO, pH 3 GO can be re-dispersed in water by magnetic stirring (no sonication) and diluted ammonia hydroxide (15% concentration) added with a drop step until pH 7 or 10 is reached, respectively. The GO suspensions with pH 7 and pH 10 can then be filtered and dried in air; resulting in pH7 GO and pH10 GO plate-like samples on filter membranes. In another aspect, pH7 GO and pH10 samples can be subjected to further drying in vacuum for two days. For example, 20 mg of dry pH7 GO and pH10 GO can be dispersed in PC and sonicated for 2 hours in a bath sonicator (VWR B2500A-MT) following the same process described in the experimental section. In one aspect, as can be seen from FIG. 5, pH10 GO has almost no dispersion in PC, whereas pH7 GO has a small degree of dispersion in PC by changing the color of PC to light green. In such an aspect, the estimated concentration of dispersed/exfoliated pH7 GO and pH10 GO in PC is less than 0.01 mg/ml and 0.05 mg/ml, respectively. As a comparison, pH3 GO can have, in one aspect, a stable dispersion at a 1 mg/ml scale.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Preparation of RG-O Powder

In a first example, GO was prepared by the modified Hummers method, followed by drying in vacuum for 3 days to obtain ‘GO powder’. Graphene oxide suspensions were obtained by dispersing GO powder in anhydrous PC (99.7%, Sigma Aldrich) with the aid of sonication in a bath sonicator (VWR B2500A-MT). After one hour of sonication, a uniform brown suspension with a concentration of 1 mg/ml was generated. Such a suspension can remain stable for several months without any precipitation evident to the eye. Thermal reduction of graphene oxide platelets in such suspensions was carried out by heating the suspension in an oil bath for 12 hours while stirring at 400 rpm with a Teflon-coated stir bar. Two temperatures were used for the thermal treatment, 150 and 200° C. After cooling down, 80 ml of heated suspension was filtered through a 47-mm diameter alumina membrane with a nominal pore size of 0.2 μm (Whatman, Middlesex, UK) to prepare RG-O powders. When a small amount (e.g., 2 ml) of heated suspension was filtered, paper-like RG-O was formed on the membrane after drying in air. Both powders and papers were subjected to further drying at 80° C. in vacuum for 2 days to minimize the residual PC in the samples. With these preparation and drying procedures, the mass of the RG-O is about 55% of that of the starting GO.

2. Characterization

In a second example, the suspension of graphene oxide platelets in PC was dropped onto native oxide/silicon and mica substrates followed by vacuum drying for SEM (FEI Quanta-600) and AFM (Park Systems XE-100) studies, respectively. SEM imaging was also done on the RG-O powders and papers. Zeta-potential measurements (Zeta Plus, Brookhaven Instruments) were done on the as-dispersed graphene oxide suspension. 10 μl of as-heated suspension was dropped onto Cu grids followed by vacuum drying at 80° C. for TEM (JEOL 2010F, 200 kV) observation. TGA (TGA 4000, Perkin Elmer) was done on the GO and RG-O powder samples. XRD (Philips X′Pert PRO, λ=1.54 Å) and XPS (Kratos AXIS Ultra DLD, A1 Kα) were done on the RG-O papers. The paper samples were also placed in the four-probe system (Keithley 6221 and 6514) to measure the conductivity of the RG-O.

For ultracapacitance measurements, 10 ml of as-heated (reduced) suspension (starting from 1 mg/ml graphene oxide suspension in PC) was filtered on alumina membranes (0.2 μm pore size) and washed with 20 ml of pure PC. The filtration lasted for 20 minutes. Then, 1 ml of TEA BF₄/PC solution (1 M) was dropped on the sample as electrolyte. The sample was kept under filtration for another 2 minutes. After the filtration was ended, black slurry was formed on the alumina membrane. A razor was used to spread the slurry evenly onto two carbon-coated aluminum foils (0.75 inch in diameter) to make electrodes. The weight of each electrode was measured to ensure that each of the two electrodes had the same amount of slurry. From the preparation procedures described above, each electrode consisted of ˜70 mg of slurry, itself a mixture of RG-O, TEA BF₄ and PC. A two-electrode cell was used to measure the capacitance. The details of sample cell assembly have been reported elsewhere. Capacitance values were calculated from the CV curves by dividing the current by the voltage scan rate, C=I/(dV/dt). Specific capacitance reported is the capacitance for the mass of RG-O in one electrode (specific capacitance=capacitance of single electrode/weight RG-O material of a single electrode), as per the normal convention. Capacitance as determined from galvanostatic charge/discharge was measured using C=I/(dV/dt) with dV/dt calculated from the slope of the discharge curve.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A composition comprising a suspension of at least one of a graphite material or a graphene material in a non-aqueous liquid.

2. The composition of claim 1, wherein the non-aqueous liquid comprises propylene carbonate.

3. The composition of claim 1, wherein suspension is free or substantially free of water.

4. The composition of claim 1, wherein the suspension is stable for at least 2 hours.

5. A method for preparing a reduced graphene oxide material, the method comprising exfoliating at least one of a graphite material or a graphene material in a non-aqueous solvent to provide a suspension.

6. The method of claim 5, wherein the graphite material or graphene material comprises graphite oxide.

7. The method of claim 5, wherein the non-aqueous solvent comprises propylene carbonate.

8. The method of claim 5, wherein the suspension is free or substantially free of water.

9. The method of claim 5, further comprising sonicating the suspension.

10. The method of claim 5, further comprising heat treating to reduce at least a portion of the suspension.

11. The method of claim 10, wherein at least a portion of the suspension comprises a plurality of graphene oxide platelets.

12. The method of claim 5, further comprising removal of all or substantially all of the propylene carbonate from the suspension.

13. The method of claim 10, wherein the reduced graphene oxide is suitable for use with an ionic liquid electrolyte.

14. The method of claim 10, further comprising forming a film of the reduced graphene oxide, wherein the film has an electrical conductivity of at least about 5,000 S/m.

15. A reduced graphene oxide material produced by the method of claim 10.

16. An ultracapacitor comprising a reduced graphene oxide, wherein the reduced graphene oxide is prepared by exfoliating graphite oxide in a non-aqueous liquid.

17. The ultracapacitor of claim 16, being capable of operative at a voltage greater than about 2.7 V.

18. The ultracapacitor of claim 16, wherein the non-aqueous liquid comprises propylene carbonate.

19. The ultracapacitor of claim 16, wherein the reduced graphene oxide has not been exposed to water.

20. The ultracapacitor of claim 16, further comprising an organic electrolyte.
